(19) United States
(12) Patent Application Publication
(10) Pub. No.: US 2026/0121679 A1
(43) Pub. Date: Apr. 30, 2026

(54) MOBILE PHONE PROTECTIVE CASE THAT CAN BE CONNECTED TO EXTERNAL DEVICE

(71) Applicant: GWD(Zhuhai) Intelligence Technology Ltd., Co., Zhuhai (CN)

(72) Inventors: Chao Wang, Zhuhai (CN); Guojin Lin, Zhuhai (CN); Yanzeng Sun, Zhuhai (CN); Xueqing Tan, Zhuhai (CN)

(73) Assignee: GWD(Zhuhai) Intelligence Technology Ltd., Co., Zhuhai (CN)

(21) Appl. No.: 19/006,566

(22) Filed: Dec. 31, 2024

(30) Foreign Application Priority Data
Oct. 24, 2024 (CN) 2024225857126

(51) Int. Cl. H04B 1/3888

(52) U.S. Cl. CPC H04B 1/3888

(57) ABSTRACT

A mobile phone protective case including: a protective case body, a circuit board and an external module; a first cavity for accommodating a mobile phone is formed on one side of the protective case body, and a second cavity is provided inside the protective case body; the circuit board is arranged in the second cavity; the external module includes an internal interface and at least one external interface connected to the circuit board; the internal interface is located in the first cavity and is used to connect to a charging port of the mobile phone; the external interface is located in the first cavity and/or the second cavity and is used to connect to an external device(s) so that the mobile phone can transmit power and/or data with the external device(s). The mobile phone protective case can also expand at least one external interface for the mobile phone.

### RELATED APPLICATIONS

This application claims priority to China Patent Application No. 2024225857126 filed on Oct. 24, 2024, the entire content of which is expressly incorporated herein in their entirety.

### TECHNICAL FIELD

The present application relates to the technical field of mobile phone accessories, in particular to a mobile phone protective case that can be connected to an external device.

### BACKGROUND ART

With the continuous advancement of technology, the variety of electronic devices has become increasingly rich, and the demand for connectivity between different devices is also growing. As one of the most commonly used electronic devices, mobile phones store a large amount of useful data, making it necessary to frequently transfer data to other electronic devices. However, at present, relying solely on a mobile phone's own interface makes it difficult to meet the need for simultaneous connections to multiple devices.

A mobile phone protective case is a common mobile accessory primarily used to prevent damage to a phone from collisions or drops. However, existing mobile phone protective cases generally provide only physical protection and lack additional functionalities. As a closely related accessory to mobile phones, mobile phone protective cases still have significant room for improvement in terms of expanding the phone's capabilities.

Based on this, the present invention hopes to provide a mobile phone protective case that can be connected to external devices, so as to improve the external connection capability of electronic devices.

### SUMMARY OF THE INVENTION

In order to overcome the deficiencies in the existing technology as mentioned above, the present application provides a mobile phone protective case that can be connected to an external device. The specific technical solutions re as follows:

The present application provides a mobile phone protective case that can be connected to an external device. The mobile phone protective case comprises: a protective case body, a circuit board, and an external module;
a first cavity for accommodating a mobile phone is formed on one side of the protective case body, and a second cavity is provided inside the protective case body;
the circuit board is arranged in the second cavity; the external module comprises an internal interface and at least one external interface connected to the circuit board;
the internal interface is located in the first cavity and is used to connect to a charging port of the mobile phone; the external interface is located in the first cavity and/or the second cavity and is used to connect to the external device so that the mobile phone can transmit power and/or data with the external device.

In a specific embodiment, the protective case body is further provided with an expansion storage interface for connecting to an external memory, and the extended storage interface is connected to the circuit board.

In a specific embodiment, a first boss is formed on a side of the protective case body facing away from the first cavity;
the expansion storage interface is arranged on the first boss; a cable is arranged inside the protective case body, and the expansion storage interface is connected to the circuit board by the cable.

In a specific embodiment, a second boss is further formed on the side of the protective case body facing away from the first cavity, the circuit board and the external module are both arranged in the second boss, and the external interface is exposed from a side wall of the second boss.

In a specific embodiment, the first boss and the second boss are located at opposite ends of the protective case body, the first boss and the second boss have the same protruding height, and the protruding heights of the first boss and the second boss are both between 5 mm and 20 mm.

In a specific embodiment, the protective case body is provided with a touch panel and/or a button(s) which is signal connected to the circuit board.

In a specific embodiment, the internal interface is fixed on the protective case body, and the internal interface is connected to the circuit board via a flexible flat cable.

In a specific embodiment, the internal interface comprises any one of a Type-C male connector, a Micro-USB male connector, and a Lightning male connector.

In a specific embodiment, the mobile phone protective case further comprises a timing module connected with the circuit board, and the timing module is used to calculate a disconnection duration between the internal interface and the electronic device.

In a specific embodiment, the at least one external interface comprises a USB interface, and/or an HDMI interface, and/or an Ethernet interface.

The present application has at least the following beneficial effects:

The present application provides a mobile phone protective case that can be connected to an external device. By providing an external module on the protective case body, the external interface of the external module can be connected to an external device, and the internal interface of the external module can be connected to the mobile phone protected by the protective case body, so that the protective case of the present application can not only provide physical protection for the mobile phone, but also connect the mobile phone to the external device. The mobile phone can transmit power and/or data with the external device via the external module, which facilitates multi-device connection for the mobile phone.

### BRIEF DESCRIPTION OF THE DRAWINGS

In order to more clearly illustrate the technical solutions in the embodiments of the present application, a brief introduction to the drawings for the description of the embodiments is provided below. Obviously, the drawings described below are only some embodiments of the present application. For a person of ordinary skill in the art, other drawings can also be obtained based on these drawings without creative work.

FIG. 1 is a schematic diagram of the overall structure of an embodiment when the protective case body is connected to a mobile phone.

FIG. 2 is a schematic diagram of the overall structure of an embodiment when the protective case body is separated from a mobile phone.

FIG. 3 is a perspective schematic diagram of the overall structure of the present application.

FIG. 4 is an exploded schematic diagram of the overall structure of the present application.

FIG. 5 is the detailed view A in FIG. 4.

FIG. 6 is a schematic diagram of the overall structure when the protective case body is connected to the mobile phone in another embodiment.

### DESCRIPTION OF ELEMENT SYMBOLS IN THE DRAWINGS

1—protective case body; 11—first boss; 12—second boss; 121—notch; 13—camera hole; 2—circuit board; 31—flexible flat cable; 32—internal interface; 4—mobile phone; 5—external interface; 6—expansion storage interface; 7—cable; 8—button; 9—first cavity; 10—cover piece.

### DESCRIPTION OF PREFERRED EMBODIMENTS

In the following, various embodiments of the present application will be described more fully. The present application may have various embodiments, and adjustments and changes may be made therein. However, it should be understood that there is no intention to limit the various embodiments of the present application to the specific embodiments disclosed herein, rather the present application should be understood to cover all adjustments, equivalents and/or alternatives that fall within the principles and scope of the various embodiments of the present application.

In the following, the terms “comprise” or “can comprise” used in various embodiments of the present application indicate the presence of disclosed functions, operations or elements, and do not limit the addition of one or more functions, operations or elements. In addition, as used in various embodiments of the present application, the terms “comprise”, “have” and the equivalents are intended only to indicate specific features, numbers, steps, operations, elements, components or combinations of the foregoing items, and should not be understood as first excluding the presence of one or more other features, numbers, steps, operations, elements, components or combinations of the foregoing items or the possibility of adding one or more features, numbers, steps, operations, elements, components or combinations of the foregoing items.

In various embodiments of the present application, the expression “or” or “at least one of A or/and B” includes any or all combinations of the words listed at the same time. For example, the expression “A or B” or “at least one of A or/and B” may include A, may include B, or may include both A and B.

The expressions used in various embodiments of the present application (such as “first”, “second”, etc.) may modify various constituent elements in various embodiments, but may not limit the corresponding constituent elements. For example, the above expressions do not limit the order and/or importance of the elements. The above expressions are only used for the purpose of distinguishing one element from other elements. For example, the first user device and the second user device indicate different user devices, although both are user devices. For example, without departing from the scope of various embodiments of the present application, the first element may be referred to as the second element, and similarly, the second element may also be referred to as the first element.

It should be noted that in the present application, unless otherwise explicitly specified and defined, the terms such as “mounting”, “connection”, “fixation” and the like should be understood in a broad sense. For example, it can be a fixed connection, a detachable connection, or an integral connection; it can be a mechanical connection or an electrical connection; it can be a direct connection or an indirect connection via an intermediate medium; it can be an internal communication between two components. For a person of ordinary skill in the art, the specific meanings of the above terms in the present application can be understood according to the specific circumstances.

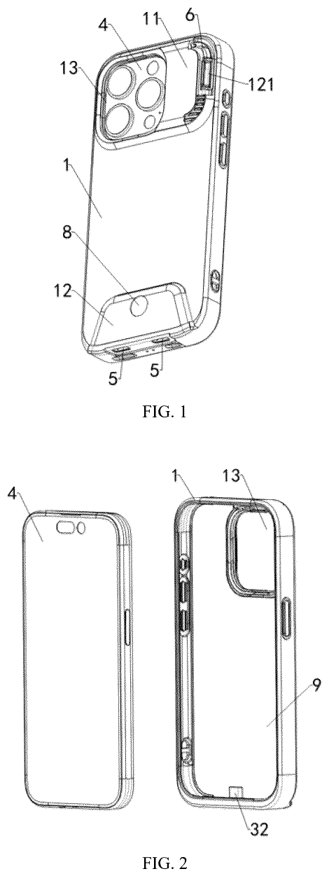

With reference to FIG. 1 to FIG. 6, the present application provides a mobile phone protective case that can be connected to an external device(s), which includes: a protective case body 1, a circuit board 2, and an external module.

Specifically, a first cavity 9 for accommodating a mobile phone 4 is formed on one side of the protective case body 1, and a second cavity is provided inside the protective case body 1. The circuit board 2 is arranged in the second cavity. The external module includes an internal interface 32 and at least one external interface 5 connected to the circuit board 2. The internal interface 32 is located in the first cavity 9 and is used to connect to a charging port of the mobile phone 4. The external interface 5 is located in the first cavity 9 and/or the second cavity and is used to connect to an external device so that the mobile phone 4 can transmit power and/or data with the external device.

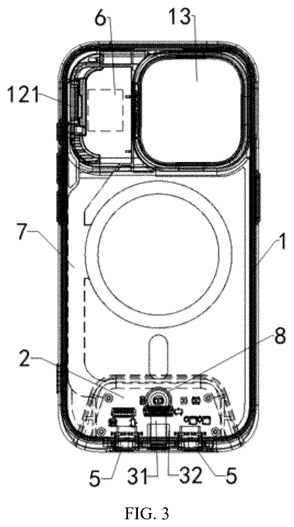

Exemplarily, the protective case body 1 can be a semi-enclosed structure as shown in FIG. 2. When in use, the protective case body 1 can semi-enclose the external mobile phone 4 to provide physical protection. Optionally, the protective case body 1 may be a hard protective case or a flexible protective cover. The mobile phone 4 may also be another type of electronic device, such as a tablet computer.

Preferably, the circuit board 2 and the external module are both arranged in the second cavity to be protected by the protective case body 1 to avoid damage caused by collision during use. The external interface 5 can be exposed from the side wall of the second cavity for connecting an external device.

It can be understood that when the present application is in use, the protective case body 1 is connected to the external mobile phone 4, for example, the protective case body 1 is detachably sleeved over the mobile phone 4, and the internal interface 32 is connected to the charging port of the mobile phone 4. In this case, the external interface 5 can be connected to an external device, thereby forming a transmission path between the mobile phone 4 and the external device, so that power transmission and/or data transmission can be performed between the mobile phone 4 and the external device.

The present application can expand the mobile phone 4 with one or more external interfaces 5, thereby improving the ability of the mobile phone 4 to connect external devices. Optionally, the specific number and type of the external interfaces 5 can be adaptively set according to actual conditions, and no specific limitation is made to this matter herein. Exemplarily, the at least one external interface 5 may include a USB interface, and/or an HDMI interface, and/or an Ethernet interface.

Among the foregoing types, the USB interface may include, for example, a USB-A interface and a USB-C interface. The USB-C interface may be configured to support PD fast charging. When the external device is a power supply device, the power supply device may be connected to the USB-C interface to quickly charge the mobile phone 4. When the external device is another type of electronic device or storage device, data connection between the external device and the mobile phone 4 may be achieved by means of connecting to the USB-A interface to facilitate data transmission between the devices. Optionally, the USB-A interface may be configured to support any one of the USB 3.0 protocol, the USB 2.0 protocol, and the USB 1.0 protocol.

In a specific embodiment, the protective case body 1 is also provided with an extended storage interface 6 for connecting to an external memory, and the extended storage interface 6 is connected to the circuit board 2. In actual use, the extended storage interface 6 is connected to an external memory so that the external memory can be connected to the mobile phone 4 via the circuit board 2 and the internal interface 32, thereby realizing the function of expanding the storage space for the mobile phone 4. The power of the mobile phone 4 can be transmitted to the extended storage interface 6 via the internal interface 32 and the circuit board 2 to power the external memory.

Exemplarily, the expansion storage interface 6 may be a TF card slot, and in this case the external memory is a TF card. A TF card control unit may be provided on the circuit board 2, and the TF card slot may be connected to the TF card control unit.

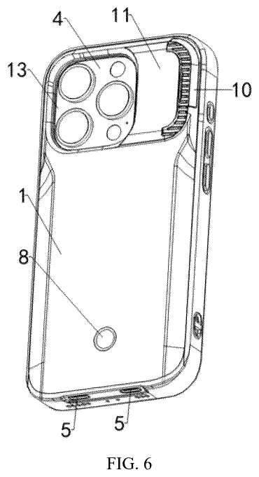

Furthermore, with reference to FIG. 1, FIG. 3 and FIG. 6, a first boss 11 can be formed on the side of the protective case body 1 away from the first cavity 9. Specifically, the expansion storage interface 6 is arranged on the first boss 11. For example, the expansion storage interface 6 may be located inside the first boss 11, and a notch 121 is provided on the side wall of the first boss 11 at a position corresponding to the expansion storage interface 6, so that the external memory can be inserted into the expansion storage interface 6 through the notch 121. Preferably, a cover piece 10 may also be provided at a position corresponding to the notch 121 on the first boss 11. The cover piece 10 may cover the notch 121 to play a protective role. A cable 7 is further provided inside the first protective case body 1, and the expansion storage interface 6 is connected to the circuit board 2 via the cable 7. Preferably, the cable 7 may be a flexible flat cable, so that the structure of the protective case body 1 can be more compact.

Furthermore, a second boss 12 can be formed on a side of the protective case body 1 facing away from the first cavity 9. The second cavity can be located in the second boss 12, the circuit board 2 and the external module are both arranged in the second boss 12, and the external interface 5 is exposed from a side wall of the second boss 12 for plugging in an external device.

Furthermore, in one embodiment, with reference to FIG. 1 again, the first boss 11 and the second boss 12 may be located at two opposite ends of the protective case body 1. Specifically, a camera hole 13 may be provided at one end of the protective case body 1, and the first boss 11 may be formed at a position close to the camera hole 13 on the protective case body 1, while the second boss 12 may be formed at another end of the protective case body 1 away from the camera hole 13, that is, at an end of the protective case body 1 corresponding to the charging port of the mobile phone 4. In this way, there can be a flat surface between the first boss 11 and the second boss 12 on the protective case body 1, and such a flat surface is convenient for a user to hold, thereby avoiding a poor holding feeling caused by protruding bosses.

In addition, preferably, the first boss 11 and the second boss 12 may have the same protruding height. It can be understood that such a design enables the protective case body 1 to remain stable when placed on a horizontal plane, avoiding shaking caused by inconsistent boss heights, thereby improving the user experience.

Exemplarily, the protrusion heights of the first boss 11 and the second boss 12 may both be between 5 mm and 20 mm. Optionally, the boss height may be adaptively set according to the specific number and type of the external interface 5. For example, when the protrusion height is 5 mm, a row of USB-C interfaces may be exposed on the second boss 12, and when the protrusion height is 20 mm, multiple rows of USB-A interfaces may be exposed on the second boss 12.

In a specific embodiment, a touch panel and/or a button 8 having a signal connection with the circuit board 2 may be provided on the protective case body 1. With reference to FIG. 1, in an embodiment in which a first boss 11 and a second boss 12 are formed, the button 8 may be provided on the second boss 12.

In one case, the button 8 can be configured to control the mobile phone 4 to connect to a specific external device. Specifically, a user can press the button 8 to make the button 8 send a control signal to the circuit board 2, and the circuit board 2 then controls the connection between the internal interface 32 and the specific external interface 5 based on the control signal, thereby realizing the function of connecting the mobile phone 4 to the specific external device. For example, if the external interface 5 includes an interface 1, an interface 2 and an interface 3, by pressing the button 8, it can make the internal interface 32 cyclically connect with the interface 1 to interface 3.

In another case, the button 8 can also be configured to determine the connection relationship between the mobile phone 4 and multiple external devices, that is, on the basis of the above situation, external devices connected to different external interfaces 5 can be further connected. Specifically, in the case where the external interface 5 includes an interface 1 and an interface 2, and both the interface 1 and the interface 2 are connected to certain external devices, in the initial state, the mobile phone 4 is connected to an external device of interface 1 by default, and the mobile phone 4 can transmit data to the external device of interface 1. When the button 8 is pressed, the mobile phone 4 is connected to the external device of interface 2. When the button 8 is pressed again, the external device of interface 1 is connected to the external device of interface 2, so that data can be transmitted between the two external devices.

In other embodiments, a touch panel may be used to replace the button 8, or the touch panel may be used to provide other extended functions such as controlling the disconnection and connection between the mobile phone 4 and an external device, without specific limitation for this matter herein. Optionally, the touch panel may be a capacitive touch panel or a resistive touch panel.

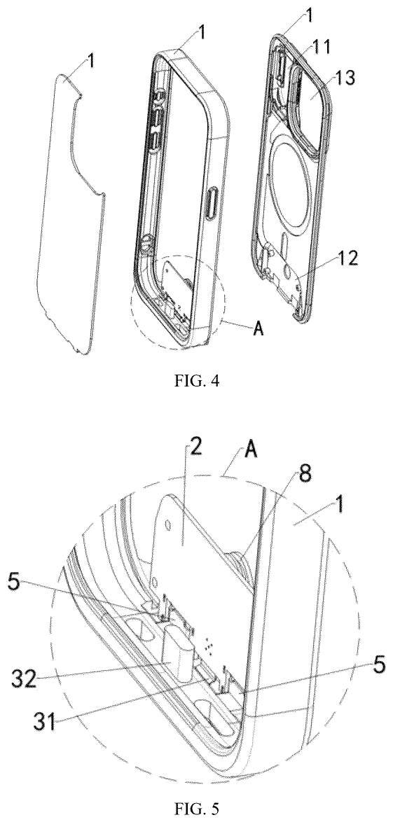

In a specific embodiment, with reference to FIG. 4 and FIG. 5, the internal interface 32 is fixed on the protective case body 1, and the internal interface 32 is connected to the circuit board 2 via a flexible flat cable 31. The flexible flat cable 31 can be located inside the protective case body 1, making the present application more aesthetically pleasing.

Optionally, the internal interface 32 may include any one of a Type-C male connector, a Micro-USB male connector, and a Lightning male connector. The type of the internal interface 32 may be adaptively set according to the specific type of the charging port of the mobile phone 4.

In a specific embodiment, a timing module connected to the circuit board 2 is further provided, and the timing module is used to calculate the disconnection duration between the internal interface 32 and the mobile phone 4. Specifically, when the internal interface 32 is disconnected from the mobile phone 4 for more than a preset time, the timing module can send a control signal to the circuit board 2, and the circuit board then automatically enters a dormant state based on the control signal to save power.

In summary, the present application provides a mobile phone protective case that can be connected to an external device. By means of providing an external module on the protective case body 1, the external interface 5 of the external module can be connected to the external device, and the internal interface 32 of the external module can be connected to the mobile phone 4 protected by the protective case body 1, so that the protective case of the present application can not only provide physical protection for the mobile phone 4, but also connect the mobile phone 4 to an external device(s). The mobile phone 4 can transmit power and/or data with the external device via the external module, which provides convenience for the multi-device connection of the mobile phone.

A person skilled in the art can understand that the accompanying drawings are only schematic diagrams of a preferred implementation scenario, and the modules or processes shown in the accompanying drawings are not necessarily required for implementing the present application.

A person skilled in the art can understand that the modules in the device in an implementation scenario can be distributed in the device of the implementation scenario according to the description of the implementation scenario, or can be changed accordingly and located in one or more devices different from the implementation scenario. The modules of the above implementation scenario can be combined into one module, or further divided into multiple sub-modules.

The element numerals used in the present application are only for the purpose of description and do not represent the advantages or disadvantages of the implementation scenarios.

The above description is merely for some preferred embodiments of the present application, and is not intended to limit the present application. Any modification, equivalent replacement, improvement, and the like made within the spirit and principle of the present application shall be included in the scope of protection of the present application.

1. A mobile phone protective case that can be connected to an external device, characterized in that the mobile phone protective case comprises: a protective case body, a circuit board, and an external module;
a first cavity for accommodating a mobile phone is formed on one side of the protective case body, and a second cavity is provided inside the protective case body;
the circuit board is arranged in the second cavity; the external module comprises an internal interface and at least one external interface connected to the circuit board;
the internal interface is located in the first cavity and is used to connect to a charging port of the mobile phone; the external interface is located in the first cavity and/or the second cavity and is used to connect to the external device so that the mobile phone can transmit power and/or data with the external device.

2. The mobile phone protective case that can be connected to an external device according to claim 1, wherein the protective case body is further provided with an expansion storage interface for connecting to an external memory, and the extended storage interface is connected to the circuit board.

3. The mobile phone protective case that can be connected to an external device according to claim 2, wherein a first boss is formed on a side of the protective case body facing away from the first cavity;
the expansion storage interface is arranged on the first boss; a cable is arranged inside the protective case body, and the expansion storage interface is connected to the circuit board by the cable.

4. The mobile phone protective case that can be connected to an external device according to claim 3, wherein a second boss is further formed on the side of the protective case body facing away from the first cavity, the circuit board and the external module are both arranged in the second boss, and the external interface is exposed from a side wall of the second boss.

5. The mobile phone protective case that can be connected to an external device according to claim 4, wherein the first boss and the second boss are located at opposite ends of the protective case body, the first boss and the second boss have the same protruding height, and the protruding heights of the first boss and the second boss are both between 5 mm and 20 mm.

6. The mobile phone protective case that can be connected to an external device according to claim 1, wherein the protective case body is provided with a touch panel and/or a button(s) which is signal connected to the circuit board.

7. The mobile phone protective case that can be connected to an external device according to claim 1, wherein the internal interface is fixed on the protective case body, and the internal interface is connected to the circuit board via a flexible flat cable.

8. The mobile phone protective case that can be connected to an external device according to claim 1, wherein the internal interface comprises any one of a Type-C male connector, a Micro-USB male connector, and a Lightning male connector.

9. The mobile phone protective case that can be connected to an external device according to claim 1, wherein the mobile phone protective case further comprises a timing module connected with the circuit board, and the timing module is used to calculate a disconnection duration between the internal interface and the electronic device.

10. The mobile phone protective case that can be connected to an external device according to claim 1, wherein the at least one external interface comprises a USB interface, and/or an HDMI interface, and/or an Ethernet interface.
